(19) United States
(12) Patent Application Publication
(10) Pub. No.: US 2016/0222876 A1
(43) Pub. Date: Aug. 4, 2016

(54) SUPERCHARGER HAVING MULTIPLE SPEEDS

(71) Applicant: Eaton Corporation, Cleveland, OH (US)

(72) Inventor: Daniel OUWENGA, Portage, MI (US)

(21) Appl. No.: 15/094,004

(22) Filed: Apr. 8, 2016

Related U.S. Application Data
(63) Continuation of application No. PCT/US2014/058776, filed on Oct. 2, 2014.
(60) Provisional application No. 61/889,819, filed on Oct. 11, 2013.
(60) Provisional application No. 61/951,149, filed on Mar. 11, 2014.

(51) Int. Cl. F02B 39/12; F02B 33/38; F02B 39/04; F16H 3/089

(52) U.S. Cl. CPC F02B 39/12; F16H 3/089; F02B 33/38; F02B 39/04

(57) ABSTRACT

A supercharger constructed in accordance to one example of the present disclosure can include a drive shaft, an input shaft, a first gear, a second gear, a first clutch and a second clutch. The second gear can have a different ratio than the first gear. The first clutch assembly can selectively couple rotatable input from the drive shaft to rotation of the input shaft through the first gear at the first drive ratio. The second clutch assembly can selectively couple rotatable input from the drive shaft to rotation of the input shaft through the second gear at a second drive ratio. The input shaft can operate in each of (i) a high speed through driving rotation of the first gear; (ii) a low speed through driving rotation of the second gear and (iii) no speed wherein both of the first and second gears are disconnected with the drive shaft.

### CROSS-REFERENCE TO RELATED APPLICATIONS

This application is a continuation of International Application No. PCT/US2014/058776 filed on Oct. 2, 2014, which claims the benefit of U.S. Patent Application No. 61/889,819 filed on Oct. 11, 2013 and U.S. Patent Application No. 61/951,149 filed on Mar. 11, 2014. The disclosures of the above applications are incorporated herein by reference.

### FIELD

The present disclosure relates generally to superchargers and more particularly to a supercharger having multiple speeds.

### BACKGROUND

Rotary blowers of the type to which the present disclosure relates are referred to as “superchargers” because they effectively super charge the intake of the engine. One supercharger configuration is generally referred to as a Roots-type blower that transfers volumes of air from an inlet port to an outlet port. A Roots-type blower includes a pair of rotors which must be timed in relationship to each other, and therefore, are driven by meshed timing gears which are potentially subject to conditions such as gear rattle and bounce. Typically, a pulley and belt arrangement for a Roots blower supercharger is sized such that, at any given engine speed, the amount of air being transferred into the intake manifold is greater than the instantaneous displacement of the engine, thus increasing the air pressure within the intake manifold and increasing the power density of the engine.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A supercharger constructed in accordance to one example of the present disclosure can include a drive shaft, an input shaft, a first gear, a second gear, a first clutch and a second clutch. The drive shaft can be connected to a pulley. The input shaft can provide a rotatable input to the supercharger. The first gear can be coupled for rotation with the input shaft. The second gear can be coupled for rotation with the input shaft. The second gear can have a different gear ratio than the first gear. The first clutch assembly can selectively couple rotatable input from the drive shaft to rotation of the input shaft through the first gear at the first drive ratio. The second clutch assembly can selectively couple rotatable input from the drive shaft to rotation of the input shaft through the second gear at a second drive ratio distinct from the first drive ratio. The input shaft can operate in each of (i) a high speed through driving rotation of the first gear; (ii) a low speed through driving rotation of the second gear and (iii) no speed wherein both of the first and second gears are disconnected from driving engagement with the drive shaft.

According to additional features, the first clutch assembly can include a first clutch rotor mounted for rotation with the drive shaft. A first clutch armature can be unconnected to the first clutch rotor. A first clutch coil can be spaced adjacent to the first clutch rotor. The first clutch coil can be configured to produce first magnetic lines of flux causing the first clutch rotor to be attracted to the first clutch armature causing a rotatable input from the drive shaft to be communicated to the input shaft through the first gear.

According to additional features, the second clutch assembly can include a second clutch rotor mounted for rotation with the drive shaft. A second clutch armature can be unconnected to the second clutch rotor. A second clutch coil can be spaced adjacent to the second clutch rotor. The second clutch coil can be configured to produce second magnetic lines of flux causing the second clutch rotor to be attracted to the second clutch armature causing a rotatable input from the drive shaft to be communicated to the input shaft through the second gear.

According to other features, the supercharger can further comprise a first transfer gear selectively coupled for rotation with the drive shaft and meshed for rotation with the first gear. The first transfer gear can be fixed for concurrent rotation with the drive shaft based on the first clutch assembly operating in the engaged position. A second transfer gear can be coupled for rotation with the drive shaft and meshed for rotation with the second gear. The second transfer gear can be fixed for concurrent rotation with the drive shaft based on the second clutch assembly operating in an engaged position. An electronic control unit can provide an electrical signal to the first and second clutch assemblies based on a sensor reading corresponding to vehicle parameters.

A supercharger according to another configuration of the present disclosure can include a drive shaft connected to a pulley. An input shaft can provide a rotatable input to the supercharger. A first gear can be coupled for rotation with the input shaft. A second gear can be coupled for rotation with the input shaft. The second gear can have a different gear ratio than the first gear. A first clutch assembly can selectively couple rotatable input from the drive shaft to rotation of the input shaft through the first gear at a first drive ratio. The first clutch assembly can have a first clutch rotor mounted for rotation with the drive shaft. A first clutch armature can be unconnected to the first clutch rotor. A first clutch coil can be spaced adjacent to the first clutch rotor. A second clutch assembly can selectively couple rotatable input from the drive shaft to rotation of the input shaft through the second gear at a second drive ratio distinct from the first drive ratio. The second clutch assembly can have a second clutch rotor mounted for rotation with the drive shaft. A second clutch armature can be unconnected to the second clutch rotor. A second clutch coil can be spaced adjacent to the second clutch rotor. The supercharger can operate in each of (i) a high speed through driving rotation of the first gear, (ii) a low speed through driving rotation of the second gear; and (iii) no speed wherein both of the first and second gears are disconnected from driving engagement with the drive shaft.

According to additional features, the first clutch coil can be configured to produce first magnetic lines of flux causing the first clutch rotor to be attracted to the first clutch armature causing a rotatable input from the drive shaft to be communicated to the input shaft through the first gear. The second clutch coil can be configured to produce second magnetic lines of flux causing the second clutch rotor to be attracted to the second clutch armature causing a rotatable input from the drive shaft to be communicated to the input shaft through the second gear. A first transfer gear can be selectively coupled for rotation with the drive shaft and meshed for rotation with the first gear. The first transfer gear can be fixed for concurrent rotation with the drive shaft based on the first clutch assembly operating in the engaged position. A second transfer gear can be selectively coupled for rotation with the drive shaft and meshed for rotation with the second gear. The second transfer gear can be fixed for concurrent rotation with the drive shaft based on the second clutch assembly operating in the engaged position. An electronic control unit can provide an electrical signal to the first and second clutch assemblies based on at least one sensor reading corresponding to at least one vehicle parameter.

A method of operating a supercharger is provided. The method can include selectively and alternatively: (i) engaging a first clutch assembly of the supercharger thereby operating the supercharger at a first speed ratio including transmitting a torque from a drive shaft, to a first transfer gear, to a first gear and to an input shaft; (ii) engaging a second clutch assembly of the supercharger thereby operating the supercharger at a second speed ratio, distinct from the first speed ratio, including transmitting a torque from a drive shaft, to a second transfer gear, to a second gear and to the input shaft, (iii) disengaging the first and second clutch assemblies of the supercharger thereby providing no torque input to the input shaft.

### BRIEF DESCRIPTION OF THE DRAWINGS

The present disclosure will become more fully understood from the detailed description and the accompanying drawings, wherein:

FIG. 1 is a schematic illustration of an intake manifold assembly having a positive displacement blower or supercharger constructed in accordance to one example of the present disclosure;

FIG. 2 is a schematic illustration of the supercharger of FIG. 1 illustrating first and second electromagnetic clutches that independently communicate a rotatable input to a first and a second respective gear;

FIG. 3 is a perspective view of a supercharger having first and second electromagnetic clutch assemblies according to one example of the present disclosure;

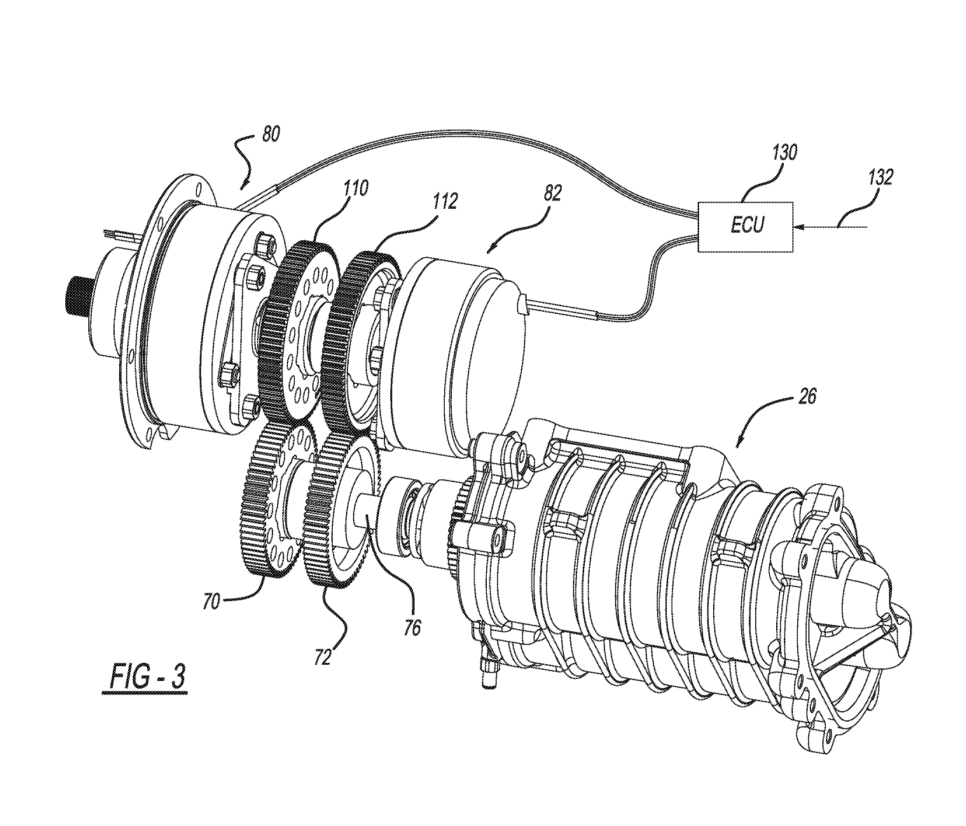

FIG. 4 is a partial cross-sectional view of the supercharger and electromagnetic clutch assemblies of FIG. 3;

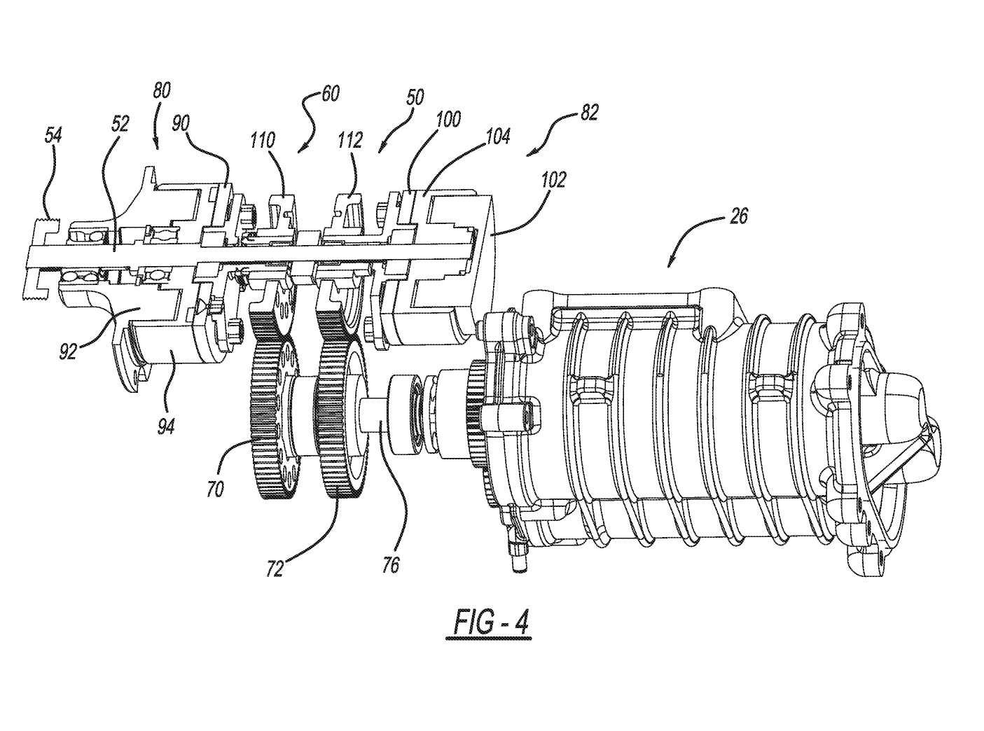

FIG. 5 is a partial cross-sectional view of the supercharger and electromagnetic clutch assemblies of FIG. 4 showing a first torque path with both of the first and second clutch assemblies disengaged;

FIG. 6 is a partial cross-sectional view of the supercharger and electromagnetic clutch assemblies of FIG. 4 showing a second (“high-speed”) torque path with the first clutch assembly engaged and the second clutch assembly disengaged; and

FIG. 7 is a partial cross-sectional view of the supercharger and electromagnetic clutch assemblies of FIG. 4 showing a third (“low-speed”) torque path with the second clutch assembly engaged and the first clutch assembly disengaged.

### DETAILED DESCRIPTION

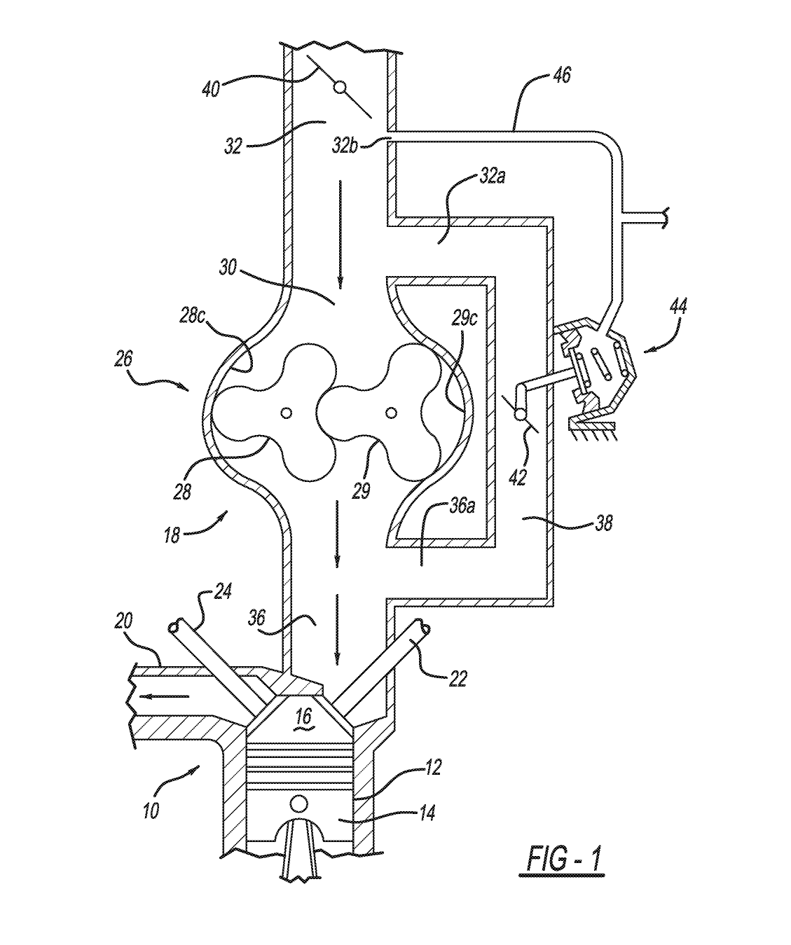

With initial reference to FIG. 1, a schematic illustration of an exemplary intake manifold assembly, including a Roots blower supercharger and bypass valve arrangement is shown. An engine 10 can include a plurality of cylinders 12, and a reciprocating piston 14 disposed within each cylinder and defining an expandable combustion chamber 16. The engine 10 can include intake and exhaust manifold assemblies 18 and 20, respectively, for directing combustion air to and from the combustion chamber 16, by way of intake and exhaust valves 22 and 24, respectively.

The intake manifold assembly 18 can include a positive displacement rotary blower 26, or supercharger of the Roots type. Further description of the rotary blower 26 may be found in commonly owned U.S. Pat. Nos. 5,078,583 and 5,893,355, which are expressly incorporated herein by reference. The blower 26 includes a pair of rotors 28 and 29, each of which includes a plurality of meshed lobes. The rotors 28 and 29 are disposed in a pair of parallel, transversely overlapping cylindrical chambers 28c and 29c, respectively. The rotors 28 and 29 may be driven mechanically by engine crankshaft torque transmitted thereto in a known manner, such as by a drive belt (not specifically shown). The mechanical drive rotates the blower rotors 28 and 29 at a fixed ratio, relative to crankshaft speed, such that the displacement of the blower 26 is greater than the engine displacement, thereby boosting or supercharging the air flowing to the combustion chambers 16.

The blower 26 can include an inlet port 30 which receives air or air-fuel mixture from an inlet duct or passage 32, and further includes a discharge or outlet port 34, directing the charged air to the intake valves 22 by means of a duct 36. The inlet duct 32 and the discharge duct 36 are interconnected by means of a bypass passage, shown schematically at reference 38. If the engine 10 is of the Otto cycle type, a throttle valve 40 can control air or air-fuel mixture flowing into the intake duct 32 from a source, such as ambient or atmospheric air, in a well know manner. Alternatively, the throttle valve 40 may be disposed downstream of the supercharger 26.

A bypass valve 42 is disposed within the bypass passage 38. The bypass valve 42 can be moved between an open position and a closed position by means of an actuator assembly 44. The actuator assembly 44 can be responsive to fluid pressure in the inlet duct 32 by a vacuum line 46. The actuator assembly 44 is operative to control the supercharging pressure in the discharge duct 36 as a function of engine power demand. When the bypass valve 42 is in the fully open position, air pressure in the duct 36 is relatively low, but when the bypass valve 42 is fully closed, the air pressure in the duct 36 is relatively high. Typically, the actuator assembly 44 controls the position of the bypass valve 42 by means of a suitable linkage. The bypass valve 42 shown and described herein is merely exemplary and other configurations are contemplated. In this regard, a modular (integral) bypass, an electronically operated bypass, or no bypass may be used.

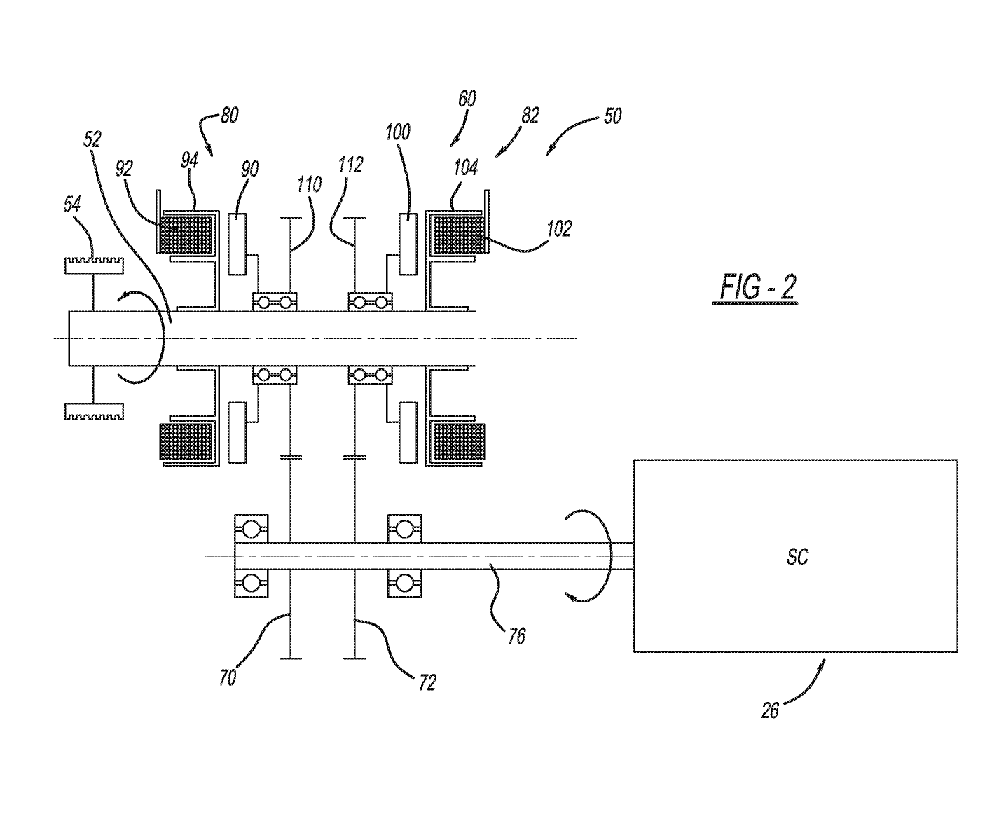

With specific reference now to FIG. 2, an input section 50 of the blower 26 is shown. The input section 50 can include a drive shaft 52, a pulley 54, a dual clutch assembly 60, a first gear 70, a second gear 72 and an input shaft 76. In the example provided, the pulley 54 can be configured to transmit torque from the engine crankshaft (not shown) to the drive shaft 52.

The dual clutch assembly 60 can generally include a first clutch assembly 80 and a second clutch assembly 82. The first clutch assembly 80 can include a first armature 90, a first coil 92 and a first rotor 94. The second clutch assembly 82 can include a second armature 100, a second coil 102 and a second rotor 104. A first transfer gear 110 can be meshed for rotation with the first gear 70. A second transfer gear 112 can be meshed for rotation with the second gear 72.

The first and second gears 70 and 72 can provide distinct drive ratios to the input shaft 76. In the example provided, the first gear 70 can be a high-gear and the second gear 72 can be a low-gear. Other configurations are contemplated.

The first clutch assembly 80 can move from a disengaged position to an engaged position. In the disengaged position, a rotational input from the drive shaft 52 is not transferred to the first gear 70. In the engaged position, a rotational input from the drive shaft 52 is transferred to the first gear 70.

In one configuration, the first clutch assembly 80 can move to the engaged position by applying an electrical current and/or voltage to the first clutch coil 92 to generate a magnetic field in the vicinity of the first clutch coil 92 and produce magnetic lines of flux. The intensity of the magnetic field may be proportional to the level of current provided. This flux may then be transferred through the small working gap between the first clutch coil 92 and the first clutch rotor 94. The first clutch rotor 94 may therefore become magnetized and set up a magnetic loop that attracts the first clutch armature 90. The first clutch armature 90 may then be urged against the first clutch rotor 94 and a frictional force may be applied at contact and the load on the first clutch armature 90 may be accelerated to match the speed of the first clutch rotor 94. As a result, the rotational input of the drive shaft 52 is communicated through the first transfer gear 110 and the first gear 70 and ultimately to the input shaft 76. When the first clutch assembly 80 is engaged, the supercharger 26 receives a rotatable input from the first or “high” gear 70 and is operating at a “high speed”.

The second clutch assembly 82 can move from a disengaged position to an engaged position. In the disengaged position, a rotational input from the drive shaft 52 is not transferred to the second gear 72. In the engaged position, a rotational input from the drive shaft 52 is transferred to the second gear 72.

In one configuration, the second clutch assembly 82 can move to the engaged position by applying an electrical current and/or voltage to the second clutch coil 102 to generate a magnetic field in the vicinity of the second clutch coil 102 and produce magnetic lines of flux. The intensity of the magnetic field may be proportional to the level of current provided. This flux may then be transferred through the small working gap between the second clutch coil 102 and the second clutch rotor 104. The second clutch rotor 104 may therefore become magnetized and set up a magnetic loop that attracts the second clutch armature 100. The second clutch armature 100 may then be urged against the second clutch rotor 104 and a frictional force may be applied at contact and the load on the clutch armature 100 may be accelerated to match the speed of the second clutch rotor 104. As a result, the rotational input of the drive shaft 52 is communicated through the second transfer gear 112 and the second gear 72 and ultimately to the input shaft 76. When the second clutch assembly 82 is engaged, the supercharger receives a rotatable input from the second or “low” gear 72 and is operating at a “low speed”.

The first and second clutch coils 92 and 102 may be controlled by an electronic control unit (ECU) 130 that provides an electrical signal to the first and second clutch coils 92 and 102. The ECU 130 may process inputs 132, such as for example, but not limited to, sensor readings corresponding to vehicle parameters and process the input according to log rules to determine the appropriate electrical signal to provide to the first and second clutch coils 92 and 102. The ECU 130 may comprise a microprocessor having sufficient memory to store the logic rules (e.g., in the form of a computer program) for controlling operation of the first and second clutch assemblies 80 and 82. The ECU 130 can provide logic that prevents both of the first and second clutch assemblies 80 and 82 from being concurrently engaged.

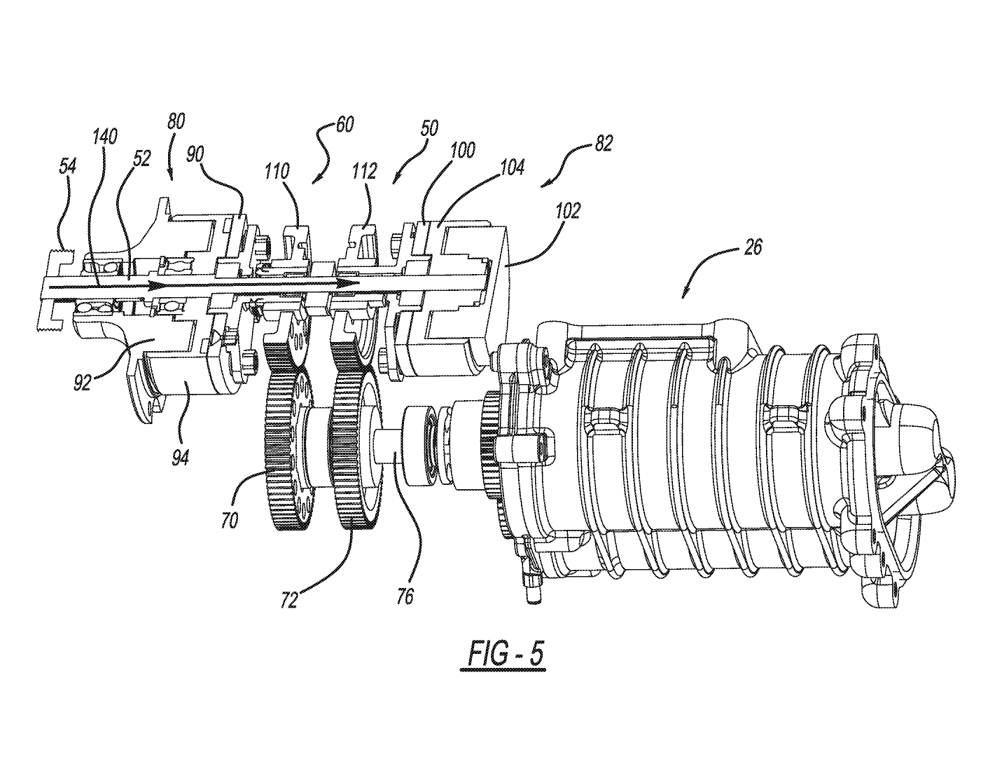

FIG. 5 is a schematic illustration of the dual clutch assembly 60 when both the first and second clutch assemblies 80 and 82 are disengaged. When the first and second clutch assemblies 80 and 82 are both in the disengaged positions, no rotatable input is transferred to the input shaft 76. A torque path 140 created from a rotatable input from the pulley 54 will merely rotate the drive shaft 52. Neither of the first and second transfer gears 110 and 112 are fixed for concurrent rotation with the drive shaft 52. In this regard, torque is not communicated to either of the first and second gears 70 and 72. The supercharger 26 is therefore “off” and not operating.

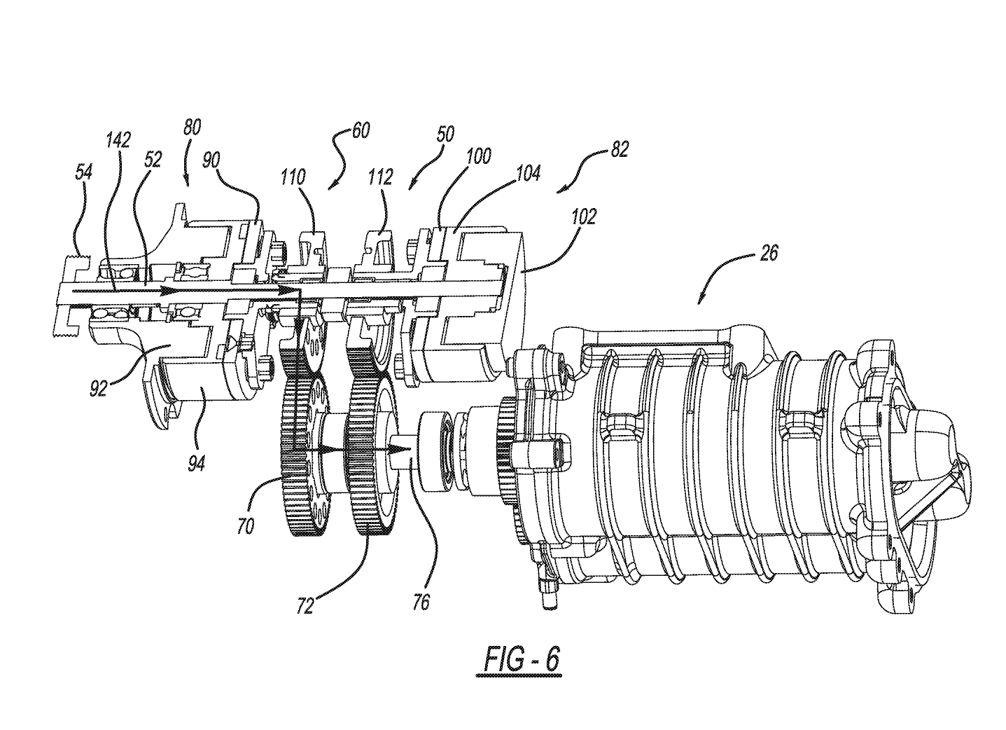

FIG. 6 is a schematic illustration of the dual clutch assembly 60 when the first clutch assembly 80 is in the engaged position and the second clutch assembly 82 is in the disengaged position. When the first clutch assembly 80 is in the engaged position, the first transfer gear 110 is fixed for concurrent rotation with the drive shaft 52 while the second transfer gear 112 is decoupled from the drive shaft 52. A rotatable input is transferred from the drive shaft 52, to the first transfer gear 110, to the first gear 70 and to the input shaft 76. A “high-speed” torque path 142 is illustrated in FIG. 6 from the drive shaft 52, to the first transfer gear 110, to the first gear 70 and to the input shaft 76.

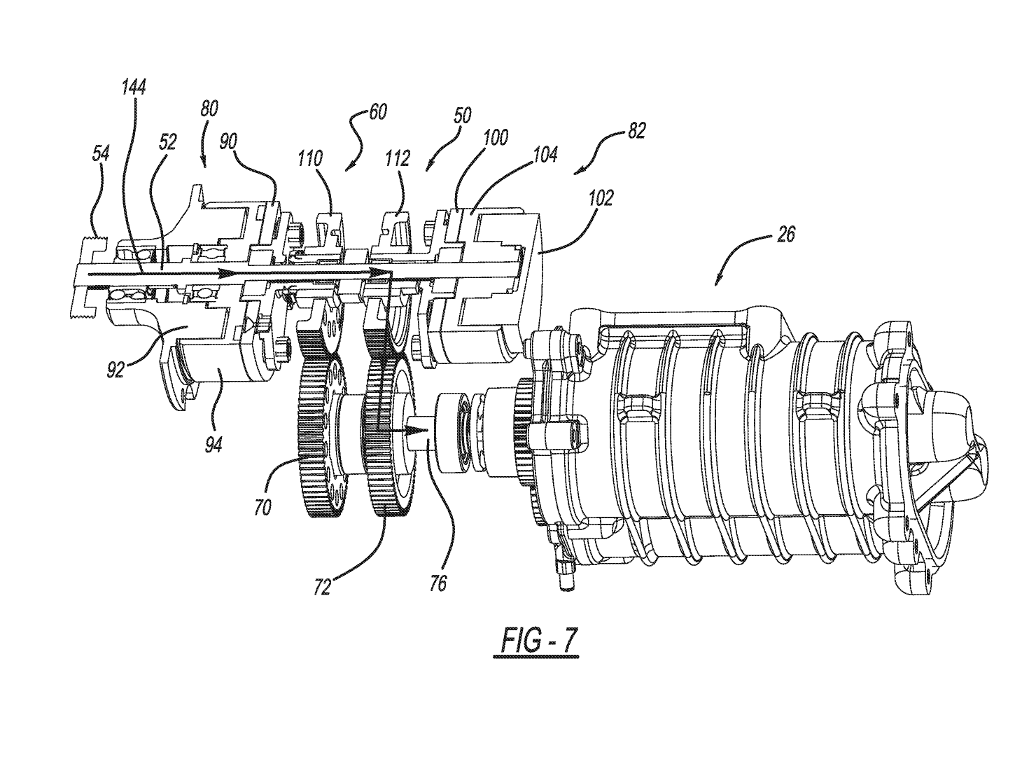

FIG. 7 is a schematic illustration of the dual clutch assembly 60 when the second clutch assembly 82 is in the engaged position and the first clutch assembly 80 is in the disengaged position. When the second clutch assembly 82 is in the engaged position, the second transfer gear 112 is fixed for concurrent rotation with the drive shaft 52 while the first transfer gear 110 is decoupled from the drive shaft 52. A rotatable input is transferred from the drive shaft 52, to the second transfer gear 112, to the second gear 72 and to the input shaft 76. A “low-speed” torque path 144 is illustrated in FIG. 7 from the drive shaft 52, to the second transfer gear 112, to the second gear 72 and to the input shaft 76.

The dual clutch assembly 60 of the input section 50 can therefore provide a “low speed” by engaging the first clutch assembly 80; a “high speed” by engaging the second clutch assembly 82; and an “off” position (no speed) when neither of the first or second clutch assemblies 80 and 82 are engaged.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A supercharger comprising:
a drive shaft connected to a pulley;
an input shaft that provides a rotatable input to the supercharger;
a first gear coupled for rotation with the input shaft;
a second gear coupled for rotation with the input shaft, the second gear having a different gear ratio than the first gear;
a first clutch assembly that selectively couples rotatable input from the drive shaft to rotation of the input shaft through the first gear at a first drive ratio; and
a second clutch assembly that selectively couples rotatable input from the drive shaft to rotation of the input shaft through the second gear at a second drive ratio, distinct from the first drive ratio;
wherein the input shaft can operate in each of (i) a high speed through driving rotation of the first gear, (ii) a low speed through driving rotation of the second gear; and (iii) no speed wherein both of the first and second gears are disconnected from driving engagement with the drive shaft.

2. The supercharger of claim 1 wherein the first clutch assembly comprises:
a first clutch rotor mounted for rotation with the drive shaft;
a first clutch armature unconnected to the first clutch rotor; and
a first clutch coil spaced adjacent to the first clutch rotor.

3. The supercharger of claim 2 wherein the first clutch coil is configured to produce magnetic lines of flux causing the first clutch rotor to be attracted to the first clutch armature causing a rotatable input from the drive shaft to be communicated to the input shaft through the first gear.

4. The supercharger of claim 1 wherein the second clutch assembly comprises:
a second clutch rotor mounted for rotation with the drive shaft;
a second clutch armature unconnected to the second clutch rotor; and
a second clutch coil spaced adjacent to the second clutch rotor.

5. The supercharger of claim 4 wherein the second clutch coil is configured to produce magnetic lines of flux causing the second clutch rotor to be attracted to the second clutch armature causing a rotatable input from the drive shaft to be communicated to the input shaft through the second gear.

6. The supercharger of claim 1, further comprising a first transfer gear selectively coupled for rotation with the drive shaft and meshed for rotation with the first gear.

7. The supercharger of claim 6 wherein the first transfer gear is fixed for concurrent rotation with the drive shaft based on the first clutch assembly operating in an engaged position.

8. The supercharger of claim 1, further comprising a second transfer gear selectively coupled for rotation with the drive shaft and meshed for rotation with the second gear.

9. The supercharger of claim 8 wherein the second transfer gear is fixed for concurrent rotation with the drive shaft based on the second clutch assembly operating in an engaged position.

10. The supercharger of claim 1, further comprising an electronic control unit that provides an electrical signal to the first and second clutch assemblies based on at least one sensor reading corresponding to at least one vehicle parameter.

11. A supercharger comprising:
a drive shaft connected to a pulley;
an input shaft that provides a rotatable input to the supercharger;
a first gear coupled for rotation with the input shaft;
a second gear coupled for rotation with the input shaft, the second gear having a different ratio than the first gear;
a first clutch assembly that selectively couples rotatable input from the drive shaft to rotation of the input shaft through the first gear at a first drive ratio, the first clutch assembly having a first clutch rotor mounted for rotation with the drive shaft, a first clutch armature unconnected to the first clutch rotor and a first clutch coil spaced adjacent to the first clutch rotor; and
a second clutch assembly that selectively couples rotatable input from the drive shaft to rotation of the input shaft through the second gear at a second drive ratio, distinct from the first drive ratio, the second clutch assembly having a second clutch rotor mounted for rotation with the drive shaft, a second clutch armature unconnected to the second clutch rotor and a second clutch coil spaced adjacent to the second clutch rotor;
wherein supercharger can operate in each of (i) a high speed through driving rotation of the first gear, (ii) a low speed through driving rotation of the second gear; and (iii) no speed wherein both of the first and second gears are disconnected from driving engagement with the drive shaft.

12. The supercharger of claim 11 wherein the first clutch coil is configured to produce first magnetic lines of flux causing the first clutch rotor to be attracted to the first clutch armature causing a rotatable input from the drive shaft to be communicated to the input shaft through the first gear.

13. The supercharger of claim 12 wherein the second clutch coil is configured to produce second magnetic lines of flux causing the second clutch rotor to be attracted to the second clutch armature causing a rotatable input from the drive shaft to be communicated to the input shaft through the second gear.

14. The supercharger of claim 11, further comprising a first transfer gear selectively coupled for rotation with the drive shaft and meshed for rotation with the first gear.

15. The supercharger of claim 14 wherein the first transfer gear is fixed for concurrent rotation with the drive shaft based on the first clutch assembly operating in an engaged position.

16. The supercharger of claim 11, further comprising a second transfer gear selectively coupled for rotation with the drive shaft and meshed for rotation with the second gear.

17. The supercharger of claim 16 wherein the second transfer gear is fixed for concurrent rotation with the drive shaft based on the second clutch assembly operating in an engaged position.

18. The supercharger of claim 11, further comprising an electronic control unit that provides an electrical signal to the first and second clutch assemblies based on at least one sensor reading corresponding to at least one vehicle parameter.

19. The supercharger of claim 13 wherein (i) the first magnetic lines of flux are transferred through a first working gap defined between the first clutch coil and the first clutch rotor and (ii) the second magnetic lines of flux are transferred through a second working gap defined between the second clutch coil and the second clutch rotor.

20. A method of operating a supercharger, the method comprising:
selectively and alternatively:
(i) engaging a first clutch of the supercharger thereby operating the supercharger at a first speed ratio including transmitting a torque from a drive shaft, to a first transfer gear, to a first gear and to an input shaft;
(ii) engaging a second clutch of the supercharger thereby operating the supercharger at a second speed ratio, distinct from the first speed ratio, including transmitting a torque from a drive shaft, to a second transfer gear, to a second gear and to the input shaft; and
(iii) disengaging the first and second clutch of the supercharger thereby providing no torque input to the input shaft.
